(19) United States
(12) Patent Application Publication
(10) Pub. No.: US 2010/0074131 A1
(43) Pub. Date: Mar. 25, 2010

(54) POWER OFFSET FOR CQI REPORTING

(75) Inventors: Eko N. Onggosanusi, Allen, TX (US); Runhua Chen, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/564,266

(22) Filed: Sep. 22, 2009

Related U.S. Application Data
(60) Provisional application No. 61/098,895, filed on Sep. 22, 2008.

(51) Int. Cl. H04L 12/26

(52) U.S. Cl. 370/252

(57) ABSTRACT

In one embodiment, the transmitter is for use with a cellular communication network and includes an offset determination unit configured to select a shift parameter for a channel quality indication, wherein the shift parameter corresponds to an adjustment in an energy per resource element ratio for reporting the channel quality indication. The transmitter also includes a sending unit configured to signal the shift parameter. In another embodiment, a receiver is for use with a cellular communication network and includes a reception unit that receives a transmission. The receiver also includes an offset interpretation unit configured to interpret a shift parameter for a channel quality indication from the transmission, wherein the shift parameter corresponds to an adjustment in an energy per resource element ratio for reporting the channel quality indication.

### CROSS-REFERENCE TO RELATED APPLICATION

This application claims the benefit of U.S. Provisional Application Ser. No. 61/098,895, filed by Eko Onggosanusi, et al. on Sep. 22, 2008, entitled “POWER OFFSET FOR CQI REPORTING,” commonly assigned with this application and incorporated herein by reference.

### TECHNICAL FIELD

This application is directed, in general, to a communication system and, more specifically, to a transmitter, a receiver and methods of operating a transmitter and a receiver.

### BACKGROUND

A key principle in orthogonal frequency division multiple access (OFDMA) communication systems is that the total operating bandwidth is divided into non-overlapping sub-bands, also called resource blocks (RBs), where transmissions for user equipment (UE) occur in an orthogonal (i.e., not mutually interfering) manner. Each RB can potentially carry data to a different UE. More typically, each UE having a sufficiently high channel quality (e.g., signal-to-interference and noise ratio (SINR) or throughput) will use a well-chosen set of RBs, so that the spectral efficiency of the transmission is maximized according to the operating principle of a scheduler. By scheduling each UE on RBs where it has high channel quality, the data rate transmitted to each UE, and therefore the overall system throughput, can be optimized according to the scheduling principle. To enable more optimum frequency domain scheduling of UEs in the RBs of the operating bandwidth, each UE feeds back a channel quality indicator (CQI) it might potentially experience for each RB or each combination of RBs to its serving base station. Improvements in this process of feeding back this information would prove beneficial in the art.

### SUMMARY

Embodiments of the present disclosure provide a transmitter, a receiver and methods of operating a transmitter and a receiver. In one embodiment, the transmitter is for use with a cellular communication network and includes an offset determination unit configured to select a shift parameter for a channel quality indication, wherein the shift parameter corresponds to an adjustment in an energy per resource element ratio for reporting the channel quality indication. The transmitter also includes a sending unit that signals the shift parameter. In another embodiment, the receiver is for use with a cellular communication network and includes a reception unit that receives a transmission. The receiver also includes an offset interpretation unit configured to interpret a shift parameter for a channel quality indication from the transmission, wherein the shift parameter corresponds to an adjustment in an energy per resource element ratio for reporting the channel quality indication.

In another aspect, the method of operating a transmitter is for use with a cellular communication network and includes selecting a shift parameter for a channel quality indication, wherein the shift parameter corresponds to an adjustment in an energy per resource element ratio for reporting the channel quality indication. The method of operating a transmitter also includes signaling the shift parameter. In yet another aspect, the method of operating a receiver is for use with a cellular communication network and includes receiving a transmission and interpreting a shift parameter for a channel quality indication from the transmission, wherein the shift parameter corresponds to an adjustment in an energy per resource element ratio for reporting the channel quality indication.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION

Reference is now made to the following descriptions taken in conjunction with the accompanying drawings, in which:

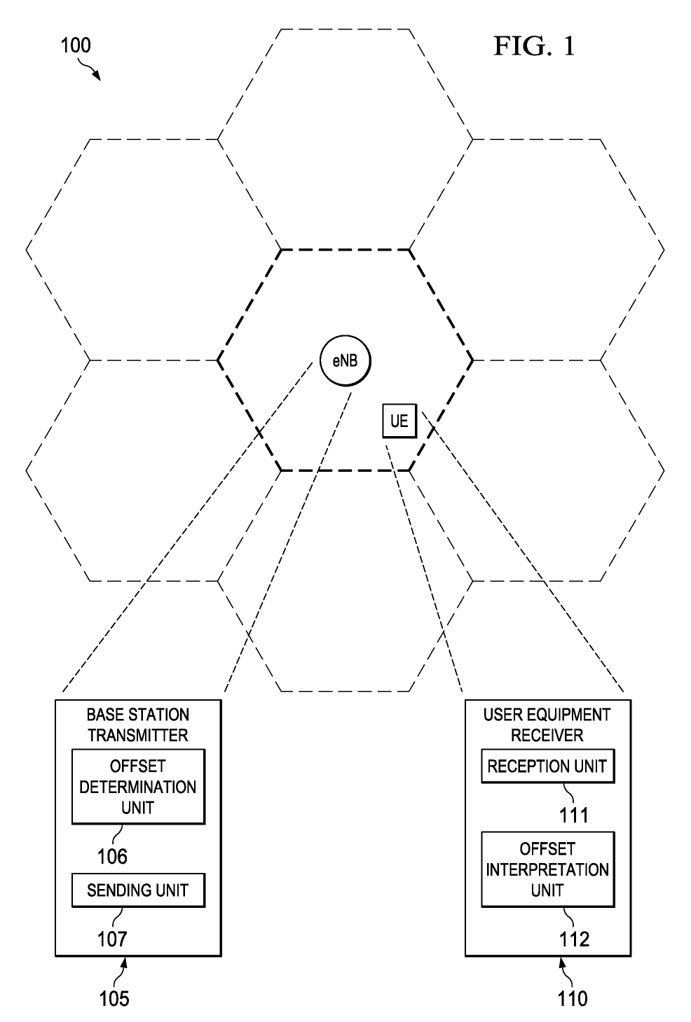

FIG. 1 illustrates an exemplary diagram of a cellular communication network employing embodiments of a transmitter and a receiver constructed according to the principles of the present disclosure;

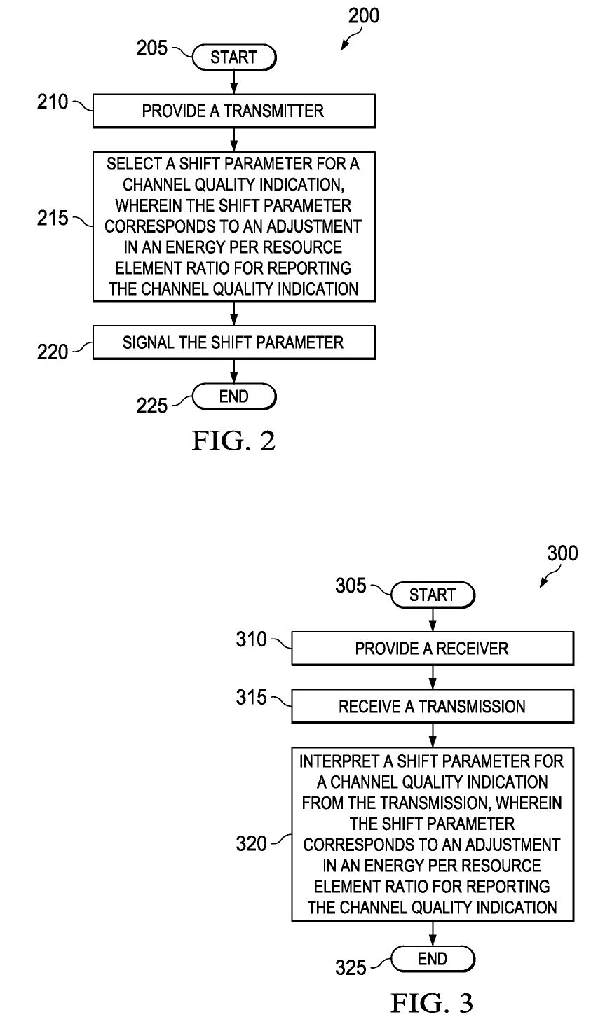

FIG. 2 illustrates an embodiment of a method of operating a transmitter carried out according to the principles of the present disclosure; and

FIG. 3 illustrates an embodiment of a method of operating a receiver carried out according to the principles of the present disclosure.

### DETAILED DESCRIPTION

Two offset parameters are used for HSPA (high-speed downlink packet access) systems. These are Γ and Δ, where Γ is a measurement power offset parameter and Δ is a reference power adjustment parameter. For non-MIMO applications and CQI (channel quality indication) reporting, UE (user equipment) assumes a total received HS-PDSCH (High-Speed Physical Downlink Shared Channel) power of P_{HSPDSCH}=P_{CPICH}+Γ+Δ (in dB). Here, P_{CPICH} is the power in the CPICH (common pilot channel), the total received power is evenly distributed among the HS-PDSCH codes of a reported CQI value, the measurement power offset Γ is signaled by higher layers, and the reference power adjustment Δ depends on a UE category.

For MIMO applications and CQI reporting, a UE assumes a total received HS-PDSCH power of H_{SPDSCH}=P_{CPICH}+Γ (in dB), where the total received power is assumed to be evenly distributed among 15 HS-PDSCH codes, and the measurement power offset parameter Γ is signaled by higher layers. If a CQI for a single TB (transport block) is reported, the reference power adjustment parameter Δ, which depends on the UE category, indicates a reference power adjustment for NodeB (base station) transmit power on indicated HS-PDSCHs.

If a CQI for two TBs is reported, the reference power adjustment parameter Δ (depending on the UE category) indicates by how much the equivalent AWGN (additive white Gaussian noise) symbol SINR (signal to interference and noise ratio) for a specific transport block would be different from one required to meet a predicted BLER (block error rate) performance.

Note that HSPA defines CQI in terms of a recommended TBS (transport block size) rather than spectral efficiency as used for E-UTRA (Evolved-UMTS Terrestrial Radio Access) systems. Also, HSPA utilizes 11 CQI tables depending on the UE category and capabilities. The following may be deduced from the above discussions.

The measurement power offset parameter Γ, which is signaled via the higher layers, is essentially the ratio between HS-PDSCH and CPICH power. This is analogous to the ratio between PDSCH (physical downlink shared channel) and CRS (common reference signal) EPRE (Energy Per Resource Element) for E-UTRA. This ratio may be derived from a cell-specific parameter P_{A} and a UE-specific physical parameter P_{B}.

The reference power adjustment parameter Δ is part of the CQI feedback (from UE to NodeB) and hence a dynamic configuration. Furthermore, the values of Δ different from zero are only defined either for the smallest or the largest recommended TBS. For non-MIMO and single TB (rank-1) MIMO transmissions, the value of Δ is always negative and used for the highest TBS in the corresponding CQI table. The value of Δ indicates that the NodeB can transmit a lower power for the recommended TBS defined by an |Δ| (in dB). Hence, this is a means of extending the range of the CQI table for a given UE category.

For a dual-TB transmission, the reference power adjustment parameter Δ is also intended to extend the range of CQI reporting for a given UE category. A maximum number of 15 OVSF (orthogonal variable spreading factor) codes and 64 QAM reception capability is either not supported by the UE or not configurable. By reporting a negative Δ value for QPSK with 15 OVSF codes, the UE notifies the NodeB to either increase the transmit power or reduce the number of OVSF codes. By reporting a positive Δ value for 16 QAM with 15 OVSF codes, the UE notifies the NodeB that lower transmit power can be used to support a 16 QAM transmission on 15 OVSF codes, which is the highest TBS for this UE category.

FIG. 1 illustrates an exemplary diagram of a cellular communication network 100 employing embodiments of a transmitter and a receiver constructed according to the principles of the present disclosure. In the illustrated embodiment, the cellular communication network 100 is part of an E-UTRA system and includes a cellular grid having a centric cell and six surrounding first-tier cells. The centric cell employs a centric base station (eNB) that includes a base station transmitter 105. The base station transmitter 105 includes an offset determination unit 106 and a sending unit 107. The UE includes a UE receiver 110 having a reception unit 111 and an offset interpretation unit 112.

In the base station transmitter 105, the offset determination unit 106 is configured to select a shift parameter for a channel quality indication, wherein the shift parameter corresponds to an adjustment in an energy per resource element ratio for reporting the channel quality indication. The sending unit 107 signals the shift parameter.

In the UE receiver 110, the reception unit 111 receives a transmission, and the offset interpretation unit 112 is configured to interpret a shift parameter for a channel quality indication from the transmission, wherein the shift parameter corresponds to an adjustment in an energy per resource element ratio for reporting the channel quality indication.

In the context of an E-UTRA system such as discussed with respect to FIG. 1, the following may be noted. Unlike HSPA, only one CQI table is specified for E-UTRA. In addition, CQI is defined in terms of the recommended DL (downlink) spectral efficiency which ranges from a QPSK rate of 0.076 to a 64 QAM rate of 0.93. As a wide range of spectral efficiencies are already provided for CQI, there seems to be no reason to extend the range for CQI. In addition, UE feedback on a per sub-frame basis, which would indicate an offset analogous to the reference power adjustment parameter Δ, is not supported in the E-UTRA system.

An equivalent of a higher-layer parameter analogous to the measurement power offset parameter Γ may be derived from a UE-specific parameter ρ_{A} and a cell-specific physical parameter P_{B}, where these parameters are semi-statically configured. This equivalent offset or shift parameter NPREO may be defined as a “nominal PDSCH-to-RS EPRE offset” (i.e., nominal physical downlink shared channel (PDSCH)-to-reference signal (RS) energy per resource element (EPRE) offset). The shift parameter NPREO is a system parameter which is signaled from the eNB to the UE (e.g., via an RRC (radio resource controller)) and is not analogous to the reference power adjustment parameter Δ discussed with respect to HSPA.

Since the shift parameter NPREO is analogous to the measurement power offset parameter Γ, NPREO allows the eNB to configure a particular UE with a different offset value for CQI reporting for that derived from ρ_{A} and P_{B}. More precisely, NPREO can be defined as a shift relative to ρ_{A}, which is a PDSCH-to-CRS EPRE ratio for OFDM symbols without CRS. That is

ρ_{A,CQI}=ρ_{A}+NPREO (in dB). (1)

Allowing the eNB to introduce a shift to ρ_{A} enables the eNB to counteract the effect of consistently optimistic or pessimistic CQI reports from a particular UE. In particular, overly pessimistic CQI reports may occur under a lightly loaded network scenario where the UE performs CQI computation based on a common RS. Overall, it is expected that pessimistic CQI reports may be more common than optimistic CQI reports. Table 1 provides an example based on this expectation.

TABLE 1
Exemplarily Mapping of NPREO (nominal PDSCH-to-RS
EPRE offset) to the shift of ρ_{A}

| Nominal PDSCH-to-RS | |
|---|---|
| EPRE Offset Field | Shift [dB] |
| 0 | −2 |
| 1 | −1 |
| 2 | 0 |
| 3 | 1 |
| 4 | 2 |
| 5 | 3 |
| 6 | 4 |
| 7 | 5 |

In addition, the shift parameter NPREO may be used as a means for the eNB to control UE throughput distributions, as required.

FIG. 2 illustrates an embodiment of a method of operating a transmitter 200 carried out according to the principles of the present disclosure. The method 200 is for use with a cellular communication network and starts in a step 205. Then, in a step 210, a transmitter is provided, and a shift parameter for a channel quality indication is selected, wherein the shift parameter corresponds to an adjustment in an energy per resource element ratio for reporting the channel quality indication, in a step 215.

In one embodiment, the shift parameter is a system parameter defined as a value that is shifted from a ratio of physical downlink shared channel energy to reference signal energy for a resource element. In another embodiment, the energy per resource element ratio corresponds to a ratio of physical downlink shared channel energy to common or cell-specific reference signal energy for a resource element. In yet another embodiment, the shift parameter is signaled by a base station via a higher layer signaling. In still another embodiment, the higher layer signaling corresponds to a radio resource control (RRC) signaling. The shift parameter is signaled in a step 220 and the method 200 ends in a step 225.

FIG. 3 illustrates an embodiment of a method of operating a receiver 300 carried out according to the principles of the present disclosure. The method 300 is for use with a cellular communication network and starts in a step 305. Then, in a step 310, a receiver is provided and a transmission is received in a step 315. A shift parameter is interpreted for a channel quality indication from the transmission, wherein the shift parameter corresponds to an adjustment in an energy per resource element ratio for reporting the channel quality indication, in a step 320.

In one embodiment, the shift parameter is a system parameter defined as a value that is shifted from a ratio of physical downlink shared channel energy to reference signal energy for a resource element. In another embodiment, the energy per resource element ratio corresponds to a ratio of physical downlink shared channel energy to common or cell-specific reference signal energy for a resource element. In yet another embodiment, the shift parameter is signaled by a base station via a higher layer signaling. In still another embodiment, the higher layer signaling corresponds to a radio resource control (RRC) signaling. The method 300 ends in a step 325.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which this application relates will appreciate that other and further additions, deletions, substitutions and modifications may be made to the described embodiments.

What is claimed is:

1. A transmitter for use with a cellular communication network, comprising:
an offset determination unit configured to select a shift parameter for a channel quality indication, wherein the shift parameter corresponds to an adjustment in an energy per resource element ratio for reporting the channel quality indication; and
a sending unit that signals the shift parameter.

2. The transmitter as recited in claim 1 wherein the shift parameter is a system parameter defined as a value that is shifted from a ratio of physical downlink shared channel energy to reference signal energy for a resource element.

3. The transmitter as recited in claim 1 wherein the energy per resource element ratio corresponds to a ratio of physical downlink shared channel energy to common or cell-specific reference signal energy for a resource element.

4. The transmitter as recited in claim 1 wherein the shift parameter is signaled by a base station via a higher layer signaling above the physical layer.

5. The transmitter as recited in claim 4 wherein the higher layer signaling corresponds to a radio resource control (RRC) signaling.

6. A method of operating a transmitter for use with a cellular communication network, comprising:
selecting a shift parameter for a channel quality indication, wherein the shift parameter corresponds to an adjustment in an energy per resource element ratio for reporting the channel quality indication; and
signaling the shift parameter.

7. The method as recited in claim 6 wherein the shift parameter is a system parameter defined as a value that is shifted from a ratio of physical downlink shared channel energy to reference signal energy for a resource element.

8. The method as recited in claim 6 wherein the energy per resource element ratio corresponds to a ratio of physical downlink shared channel energy to common or cell-specific reference signal energy for a resource element.

9. The method as recited in claim 6 wherein the shift parameter is signaled by a base station via a higher layer signaling.

10. The method as recited in claim 9 wherein the higher layer signaling corresponds to a radio resource control (RRC) signaling.

11. A receiver for use with a cellular communication network, comprising:
a reception unit that receives a transmission; and
an offset interpretation unit configured to interpret a shift parameter for a channel quality indication from the transmission, wherein the shift parameter corresponds to an adjustment in an energy per resource element ratio for reporting the channel quality indication.

12. The receiver as recited in claim 11 wherein the shift parameter is a system parameter defined as a value that is shifted from a ratio of physical downlink shared channel energy to reference signal energy for a resource element.

13. The receiver as recited in claim 11 wherein the energy per resource element ratio corresponds to a ratio of physical downlink shared channel energy to common or cell-specific reference signal energy for a resource element.

14. The receiver as recited in claim 11 wherein the shift parameter is signaled by a base station via a higher layer signaling.

15. The receiver as recited in claim 14 wherein the higher layer signaling corresponds to a radio resource control (RRC) signaling.

16. A method of operating a receiver for use with a cellular communication network, comprising:
receiving a transmission; and
interpreting a shift parameter for a channel quality indication from the transmission, wherein the shift parameter corresponds to an adjustment in an energy per resource element ratio for reporting the channel quality indication.

17. The method as recited in claim 16 wherein the shift parameter is a system parameter defined as a value that is shifted from a ratio of physical downlink shared channel energy to reference signal energy for a resource element.

18. The method as recited in claim 16 wherein the energy per resource element ratio corresponds to a ratio of physical downlink shared channel energy to common or cell-specific reference signal energy for a resource element.

19. The method as recited in claim 16 wherein the shift parameter is signaled by a base station via a higher layer signaling.

20. The method as recited in claim 19 wherein the higher layer signaling corresponds to a radio resource control (RRC) signaling.
